(19) United States
(12) Patent Application Publication
(10) Pub. No.: US 2013/0014355 A1
(43) Pub. Date: Jan. 17, 2013

(54) WATERPROOF ZIPPER, METHOD AND APPARATUS FOR MANUFACTURING THE SAME

(71) Applicant: Young Hee LEE, Seoul (KR)

(72) Inventor: Young Hee LEE, Seoul (KR)

(73) Assignee: UNIZIN COMPANY, Seoul (KR)

(21) Appl. No.: 13/195,498

(22) Filed: Aug. 1, 2011

(30) Foreign Application Priority Data
Jul. 11, 2011 (KR) 10-2011-0068287

(51) Int. Cl. A44B 19/32; B32B 38/16; B32B 38/10

(52) U.S. Cl. 24/389; 156/192; 156/390

(57) ABSTRACT

A waterproof zipper, a method and an apparatus for manufacturing the same are provided, which can be provided with water resistance, implement diverse shapes and colors through a print layer formed on the zipper, and prevent the print layer from peeling off due to ultraviolet rays or a sliding operation of a slider. The waterproof zipper includes a zipper having one surface to which a plurality of elements are attached so that the elements are engaged with each other in a length direction of the zipper, and a waterproof film made of a transparent polyurethane material and having one surface on which a print layer is formed and which is attached to the other surface of the zipper.

### CROSS-REFERENCE TO RELATED APPLICATION

This application is based on and claims priority from Korean Patent Application No. 10-2011-0068287, filed on Jul. 11, 2011 in the Korean Intellectual Property Office, the disclosure of which is incorporated herein in its entirety by reference.

### BACKGROUND OF THE INVENTION

1. Field of the Invention

The present invention relates to a waterproof zipper, and more particularly to a waterproof zipper, a method and an apparatus for manufacturing the same, which can be provided with water resistance, implement diverse shapes and colors through a print layer formed on the zipper, and prevent the print layer from peeling off due to ultraviolet rays or a sliding operation of a slider.

2. Description of the Prior Art

In general, waterproof zippers, which are provided with water resistance and are used in clothes, bags, shoes, and the like, have been widely used. The waterproof zipper is manufactured in a manner that a large number of elements, which are engaged with each other when the zipper is fastened, are attached to one surface of the zipper in a length direction of the zipper, and a waterproof film of a polyurethane material is attached to the other surface of the zipper. A waterproof zipper in the related art is disclosed in Korean Utility Model Registration No. 20-0168587.

In manufacturing a waterproof zipper, a method of heating an adhesive polyurethane film, putting the heated polyurethane film on a zipper, and pressing the polyurethane film on the zipper using a pressure roller, or a method of sewing a waterproof film on a zipper surface or elements to strengthen the adhesive force between the zipper and the waterproof film has been used.

However, the method of heating the waterproof film and pressing the heated waterproof film on the zipper has the problems in that the waterproof film may peel off due to frequent use of the zipper, and this may cause the waterproof function to be deteriorated and may spoil the beauty of the zipper. Further, the method of sewing the waterproof film on the zipper surface or the elements to form a sewing line has the problems in that the waterproof film may be damaged during the sewing, and water may soak through the sewed portions to deteriorate the waterproof function.

In order to solve the above-described problems, the inventor has filed a patent application no. 10-2008-22050 for the invention entitled “an apparatus for manufacturing a waterproof zipper”, and has obtained a registered patent no. 10-924587.

Although the registered patent no. 10-924587 can solve the problems of the waterproof zipper that is manufactured by the method of manufacturing the waterproof zipper in the related art, there is increasing concern about giving of visual effects to the zipper in addition to the water resistance of the zipper.

For this, diverse color patterns have been printed on the waterproof zipper. In this case, however, since such patterns are printed on the surface of the waterproof film that is exposed to outside when the waterproof zipper is attached to clothes or bags, the print portion is directly exposed to outside and thus the print portion may peel off due to the ultraviolet rays. Further, when the slider of the zipper slides, the print portion peels off severely.

Further, in the case of attaching the waterproof zipper to clothes or bags, water may minutely soaks between the waterproof films which are in contact with each other, and the waterproof zipper in the related art has the problem in that the zipper gets wet due to the water that minutely soaks between the waterproof films.

### SUMMARY OF THE INVENTION

Accordingly, the present invention has been made to solve the above-mentioned problems occurring in the related art while advantages achieved by the prior art are maintained intact.

An embodiment of the present invention proposes a waterproof zipper which can be provided with water resistance, implement diverse shapes and colors through a print layer formed on the zipper, and prevent the print layer from peeling off due to ultraviolet rays or a sliding operation of a slider.

Another embodiment of the present invention proposes a waterproof zipper which can make water run down the zipper so that the zipper does not get wet even if the water minutely soaks into the inside through a gap between waterproof films. Still another embodiment of the present invention proposes a method and an apparatus for manufacturing a waterproof zipper, which can make a zipper and a waterproof film strongly adhere to each other and can make water, which minutely soaks into a gap between waterproof films, run down the zipper without soaking into the zipper.

In one aspect of the present invention, there is provided a waterproof zipper, which includes a zipper having one surface to which a plurality of elements are attached so that the elements are engaged with each other in a length direction of the zipper; and a waterproof film made of a transparent polyurethane material and having one surface on which a print layer is formed and which is attached to the other surface of the zipper.

In the waterproof zipper according to one aspect of the present invention, the print layer of the waterproof film may be an opaque layer on which opaque ink is coated, and a color of the other surface of the zipper may be exposed through a transparent portion on which the print layer is not formed.

In the waterproof zipper according to one aspect of the present invention, a water repellent material may be spread on the one surface of the zipper.

In another aspect of the present invention, there is provided an apparatus for manufacturing a waterproof zipper, which attaches a waterproof film on which a print layer is formed to the other surface of a zipper having one surface to which a plurality of elements are attached so that the elements are engaged with each other in a length direction of the zipper, which includes a water repellent processing unit spreading a water repellent material on the one surface of the zipper; an adhesive unit making the surface of the waterproof film adhere to the other surface of the zipper by spreading adhesives on the other surface of the zipper and making the zipper and the waterproof film simultaneously pass through a pressure roller; a heating unit provided on one side of the adhesive unit to heat the waterproof zipper while the waterproof zipper to which the waterproof film adheres through the adhesive unit is transported; a pressure unit provided on one side of the heating unit to transport the waterproof zipper that is heated by the heating unit to a plurality of pressure rollers and to press the heated waterproof zipper; a cooling unit provided on one side of the pressure unit to cool the waterproof zipper while the waterproof zipper that is pressed by the pressure unit is transported; a drawing unit provided on one side of the cooling unit to draw the waterproof zipper that is cooled by the cooling unit to a pair of pressure rollers and to press the cooled waterproof zipper; and a winding unit provided to be spaced apart for a predetermined distance from one side of the drawing unit to make the drawn waterproof zipper automatically wound.

Here, the water repellent processing unit may include a housing having a hexahedron shape of which the front surface is open to form an inner space portion and having an inlet port and an outlet port through which the zipper passes, a cover rotatably coupled to the housing to open or close the open portion of the housing, a cylindrical main guide mounted in a position that is higher than the inlet port and the outlet port of the housing to project from a center portion of an inner surface of the housing in a horizontal direction, first and second sub-guides mounted on both sides of a lower portion of the main guide on the inner surface of the housing, and an injector mounted to be adjacent to an upper end corner of the inner surface of the housing to inject the water repellent material, wherein in a process where the zipper having passed through the inlet port of the housing is guided to the outlet port of the housing by the first sub-guide, the main guide, and the second sub-guide, the water repellent material that is injected from the injector positioned on an upper side is spread on the one surface of the zipper.

According to the waterproof zipper according to the present invention, since the surface on which the print layer of the waterproof film is formed is attached to the zipper, the print layer is not directly exposed to the outside, and thus the print layer is prevented from peeling off due to the ultraviolet rays or the sliding operation of the slider.

Further, since the water repellent material is spread on the surface to which the elements of the zipper are attached, the water runs down the zipper even if the water minutely soaks into the inside through the gap between the waterproof films, and thus the zipper does not get wet.

Further, according to the method and the apparatus for manufacturing a waterproof zipper according to the present invention, the zipper and the waterproof film strongly adhere to each other, and through the spreading of the water repellent material on the zipper, the water, which minutely soaks in between the waterproof films, runs down the zipper without soaking into the zipper to prevent the zipper from getting wet.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a waterproof zipper according to an embodiment of the present invention;

FIG. 2 is an exploded perspective view of the waterproof zipper illustrated in FIG. 1;

FIG. 3 is a cross-sectional view taken along line A-A′ of FIG. 1;

FIG. 4 is a schematic view explaining a process of manufacturing a waterproof film of the waterproof zipper illustrated in FIG. 1;

FIG. 5A is a plan view of a waterproof zipper according to another embodiment of the present invention;

FIG. 5B is a plan view of a waterproof zipper according to still another embodiment of the present invention; and

FIGS. 6 to 12 are views illustrating an apparatus for manufacturing a waterproof zipper according to the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

Referring to FIGS. 1 to 3, a waterproof zipper according to an embodiment of the present invention will be described. As illustrated, the waterproof zipper includes a zipper 10 and a waterproof film 20.

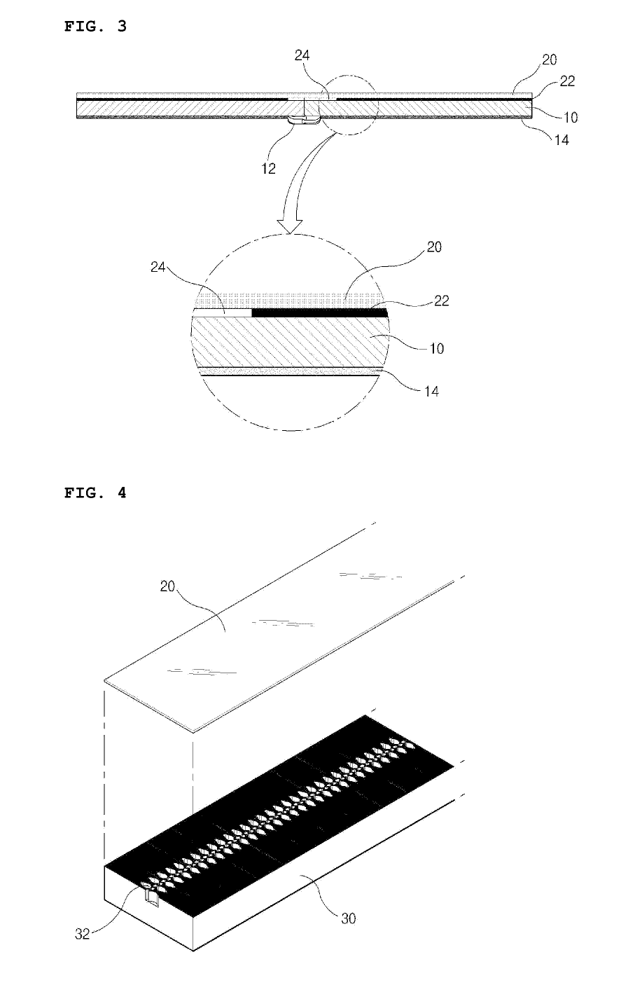

The zipper 10 is provided with a plurality of elements 12 which are attached on one surface of the zipper 10 so that the elements 12 are engaged with each other in a length direction of the zipper 10. Preferably, as illustrated in FIG. 3, a water repellent material is spread on one surface of the zipper 10 to form a water repellent layer 14. Once the water repellent material is spread on the zipper, water, which minutely soaks in between the waterproof films 20 attached to the zipper 10, runs down without soaking into the zipper 10, and thus the zipper 10 is prevented from getting wet.

The waterproof film 20 is attached to the other surface of the zipper 10 having one surface to which elements 12 are attached. The waterproof film 20 is made of a transparent polyurethane material, and one surface of the waterproof film 20, a print layer 22 is formed. Here, the surface on which the print layer 22 of the waterproof film 20 is formed is attached to the other surface of the zipper 10, and the print layer 22 is positioned between the waterproof film 20 and the zipper 10. Accordingly, since the print layer 22 is positioned between the waterproof film 20 and the zipper 10 and is not directly exposed to the outside, the print layer 22 is prevented from peeling off due to ultraviolet rays or a sliding operation of a slider 16.

On the other hand, it is preferable that the print layer 22 of the waterproof film 20 may be an opaque layer on which opaque ink is coated. As described above, the waterproof film 20 is made of a transparent polyurethane material, and if the print layer 22 is formed by coating the opaque ink, the shape and the color of the print layer 22 are shown to outside, and the color of the other surface of the zipper 10 is exposed through a transparent portion 24 on which the print layer 22 is not formed. For example, if the print layer 22 is formed with black and the color of the other surface of the zipper 10 is not exposed to the outside, the shape of the unprinted transparent portion 24 and the color of the other surface of the zipper are shown to the outside together. Accordingly, by diversely forming the shape of the transparent portion 24 and diversely taking colors of the zipper 10, diverse visual effects can be obtained.

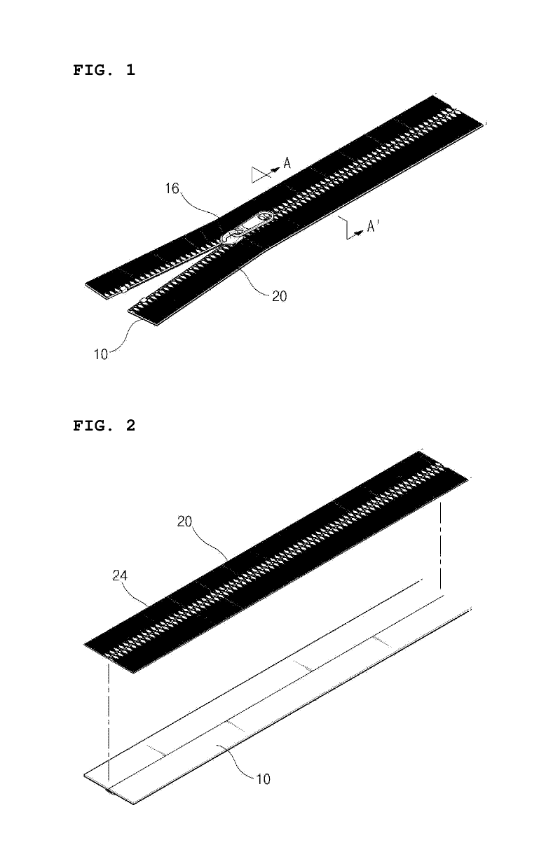

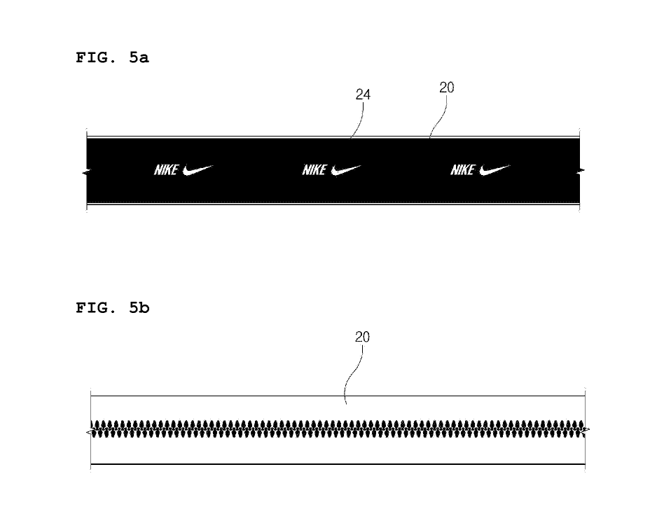

The transparent portion 24 of the waterproof film 20, as illustrated in FIGS. 1 and 2, may be arranged to form a set of teeth, and in this case, the transparent portion 24 may be arranged from a center portion of the waterproof film in a length direction of the zipper so that the transparent portion 24 corresponds to the arrangement of the elements 12 that are attached to the zipper 10. In addition, the transparent portion 24 of the waterproof film 20 may be formed to have a shape as illustrated in FIG. 5A, and may be formed in diverse shapes according to a manufacturer's need.

On the other hand, in the waterproof film 20 of the waterproof zipper as illustrated in FIGS. 1 and 2, the opaque layer and the transparent portion may be changed each other. For example, by forming the print layer 22 of the opaque layer that forms the set of teeth in the center portion of the waterproof film 20 in the length direction as shown in FIG. 5B and putting the surrounding portions in a transparent state, the waterproof zipper may have a sense of beauty that is different from that of the waterproof zipper as illustrated in FIGS. 1 and 2.

A process of manufacturing the waterproof film will be described with reference to FIG. 4. FIG. 4 is a schematic view explaining a process of manufacturing a waterproof film of the waterproof zipper illustrated in FIG. 1. As illustrated, a copperplate 30 for forming the print layer of the waterproof film is formed. On the copperplate 30, a groove 32 is formed to have a shape that corresponds to the transparent portion of the waterproof film 20, and ink is spread on the upper surface of the copperplate 30 on which the groove 32 is not formed. If the ink is spread on the copperplate 30, a print layer is formed on the lower surface of the waterproof film 20 by placing the waterproof film 20 of a transparent polyurethane material on the copperplate 30. If the print layer is formed on the waterproof film 20, the transparent portion is formed in a shape that corresponds to the shape of the groove 32 of the copperplate 30.

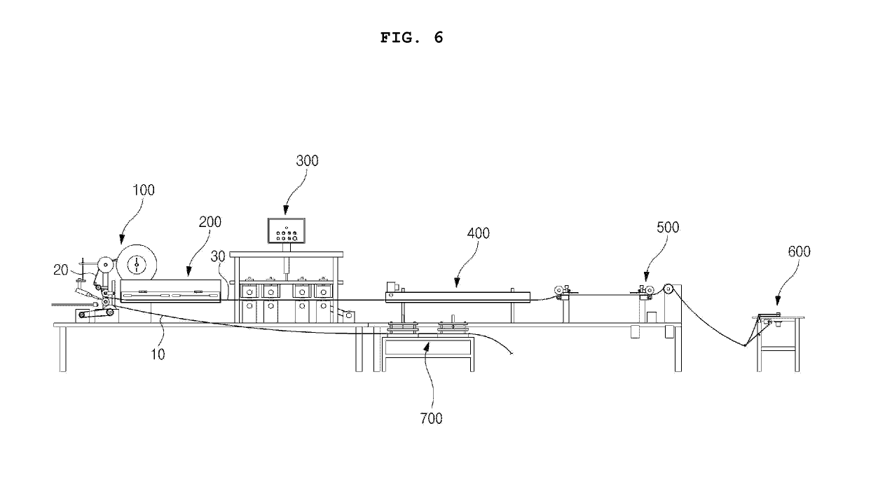

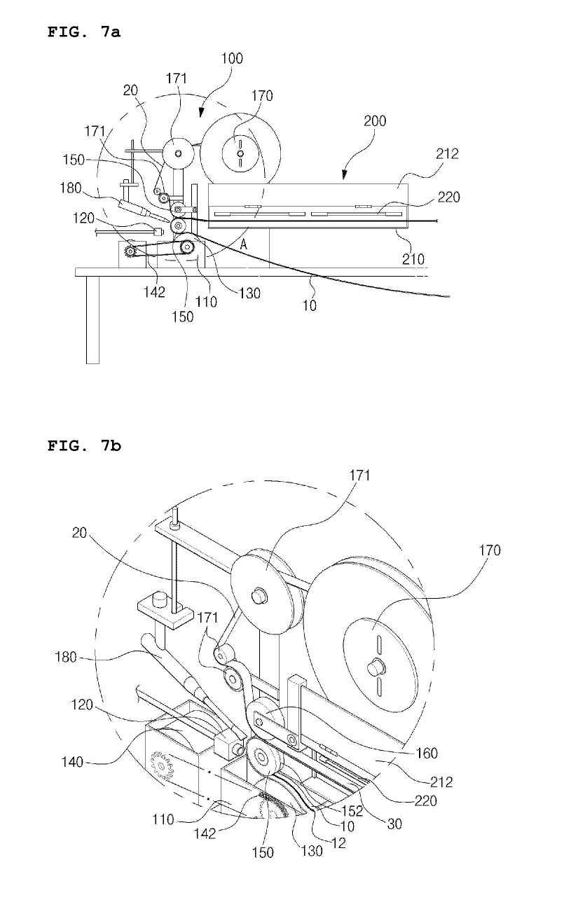

The method of manufacturing a waterproof zipper according to an embodiment of the present invention includes a water repellent processing step of spreading a water repellent material on the one surface of the zipper 10; an adhesion step of making the surface of the waterproof film 20, on which the print layer 22 of the waterproof film 20 is formed, adhere to the other surface of the zipper 10 by spreading adhesives on the other surface of the zipper 10 and making the zipper 10 and the waterproof film 20 simultaneously pass through a pressure roller; a heating step of heating the waterproof zipper 30, in which the zipper 10 and the waterproof film 20 adhere to each other, while transporting the waterproof zipper 30; a pressure step of transporting the heated waterproof zipper 30 to a plurality of pressure rollers and pressing the heated waterproof zipper 30; a cooling step of cooling the pressed waterproof zipper while transporting the pressed waterproof zipper; a drawing step of drawing the cooled waterproof zipper; a winding step of making the drawn waterproof zipper automatically wound on a winding roll; a step of hardening the waterproof zipper wound on the winding roll; and a cutting step of cutting a center portion of the waterproof film 20 along the length direction while unwinding the waterproof zipper from the winding roll after the hardening is completed. This method of manufacturing a waterproof zipper will be described in detail with reference to FIGS. 6 to 12.

First, the zipper 10 having one surface to which a plurality of elements are attached and the waterproof film 20 on which the print layer 22 is formed are separately prepared. The method of manufacturing the waterproof film 20 is as described above.

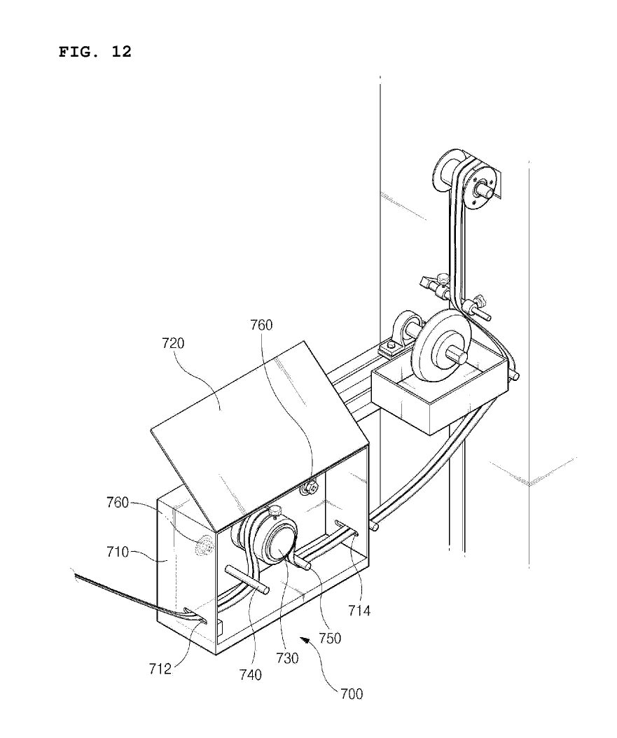

Before entering into a process of adhering the zipper 10 and the waterproof film 20 to each other, a water repellent process of spreading a water repellent material on the surface to which the elements of the zipper 10 are attached is performed. The water repellent process is performed through a water repellent processing unit 700, and as illustrated in FIG. 12, the water repellent processing unit 700 includes a housing 710, a cover 720, a main guide 730, a first sub-guide 740, a second sub-guide 750, and an injector 760. The water repellent material is spread on the zipper 10 in a process of transporting the zipper 10 in a state where the elements are directed upward.

The housing 710 substantially has a hexahedron shape of which the front surface is open to form an inner space portion (which is not denoted by a drawing reference numeral), and an inlet port 712 and an outlet port 714, through which the zipper 10 passes, are formed on both sides of a lower end portion substantially to face each other. The zipper 10 is transported and passes through the inlet port 712 and the outlet port 714 of the housing 710 so that the elements are directed upward.

The cover 720 is rotatably coupled to the housing 710 to open or close the open portion of the housing 710, and serves to prevent the water repellent material that is injected by the injector 760 from leaking out of the housing 710.

The main guide 730 is mounted in a position that is higher than the inlet port 712 and the outlet port 714 of the housing 710 to project from the center portion of an inner surface of the housing 710 in a horizontal direction. The main guide 730 is substantially in a cylindrical shape so that the zipper 10 can be transported in a state where the other surface of the zipper 10, to which the elements are not attached, is placed on the main guide 730. The main guide 730 is formed so that the length of the main guide 730 is longer than the width of the zipper 10.

The first sub-guide 740 and the second sub-guide 750 are mounted on both sides of a lower portion of the main guide 730 on the inner surface of the housing 710 to guide the transport of the zipper 10. It is preferable that the first sub-guide 740 and the second sub-guide 750 are mounted substantially to be even with the inlet port 712 and the outlet port 714 of the housing 710, and thus the zipper 10 can be transported in a horizontal state. In this case, the zipper 10 that is transported to pass through the inlet port 712 of the housing 710 is transported to the main guide 730 that is positioned on the upper side of the first sub-guide 740 in a state where the zipper 10 is bent from the lower end of the first sub-guide 740 to the right upper side. The zipper 10 having passed through the main guide 730 is transported to the second sub-guide 750 that is positioned on the lower side of the main guide 730 in a state where the zipper 10 is bent to the right lower side, and then is horizontally transported in a state where the zipper 10 is bent from the lower end of the second sub-guide 750 to the right side.

The injector 760 is mounted to be adjacent to an upper end corner of the inner surface of the housing 710 and serves to inject the water repellent material. It is preferable that the injector 760 is positioned on the upper side of a section where the zipper 10 is transported in a horizontal state in order to heighten the spreading efficiency of the water repellent material.

For reference, a pressure roller may be provided on an outer side of the outlet port 714 of the housing to provide a power for transporting the zipper 10.

If the water repellent process is completed, as illustrated in FIG. 6, the an adhesion step performed by an adhesive unit 100, the heating step performed by a heating unit 200, the pressure step performed by a pressure unit 300, the cooling step performed by a cooling unit 400, the drawing step performed by a drawing unit 500, and the winding step performed by a winding unit 600 are performed in order, and then the step of hardening the waterproof zipper wound on the winding roll, and the cutting step of cutting the center portion of the waterproof film along the length direction while unwinding the waterproof zipper from the winding roll after the hardening is completed are performed to complete the manufacturing of the waterproof zipper.

The adhesive process is performed by the adhesive unit 100. The adhesive unit 100 serves to make the surface of the waterproof film adhere to the other surface of the zipper by spreading adhesives on the other surface of the zipper and making the zipper and the waterproof film simultaneously pass through a pressure roller. As illustrated in FIGS. 7A and 7B, the adhesive unit 100 includes an adhesive accommodation box 110, an adhesive supply hose 120, a first roller 130, a first drive motor 140, a second roller 150, a third roller 160, and a film roll 170. Preferably, the adhesive unit 100 may further include an air heater 180.

The adhesive accommodation box 110 is formed to have an upper open end and a space portion formed therein, and the adhesives are filled therein. Further, on both surfaces of the adhesive accommodation box 110, through-holes are formed so that the first roller 130 is inserted into and is rotatably coupled to the adhesive accommodation box 110.

The adhesive supply hose 120 serves to supply the adhesives to the inside of the adhesive accommodation box 110, and is provided on an upper portion of the adhesive accommodation box 110. Although not illustrated in the drawing, the adhesive supply hose 120 is connected to a separate adhesive storage container, and the adhesives stored in the adhesive storage container are supplied to the adhesive accommodation box 110 through the adhesive supply hose 120. The first roller 130 serves to spread the adhesives on the other surface of the zipper 10. The first roller 130 is rotatably inserted into the inside of the adhesive accommodation box 110, and a predetermined portion thereof is exposed to the upper side. As the first roller 130 is inserted into the inside of the adhesive accommodation box 110, the outer circumference of the first roller 130 is stained with the adhesives, and as described later, the adhesives are automatically spread on the other surface of the zipper 10, which is in contact with the outer circumference of the first roller 130, when the zipper 10 is supplied to be drawn between the first roller 130 and the second roller 150.

The first drive motor 140 serves to provide a driving force to the first roller 130, and may be connected to the first roller 130 through a chain 142. As gears (which are not denoted by drawing reference numerals) that are engaged with the respective shafts of the first drive motor 140 and the first roller 130 are connected through the chain 142, the driving force of the first drive motor 140 is transferred to the first roller 130 to rotate the first roller 130.

The second roller 150 serves to assist the spreading of the adhesives on the other surface of the zipper 10 through the first roller 130. The second roller 130 is installed on an upper portion of the first roller so that the outer circumference thereof is in close contact with the outer circumference of the first roller 130, and when the first roller 130 is rotated, its driving force is transferred to the second roller 150 to rotate the second roller 150 in the opposite direction.

The zipper 10 is inserted between the first roller 130 and the second roller 150 in a state where one surface of the zipper 10 to which the elements 12 are attached becomes an upper surface and the other surface of the zipper 10 becomes in contact with the outer circumference of the first roller 130. At this time, on the outer circumference of the second roller 150, a groove 152 may be formed to correspond to the elements on the one surface of the zipper 10, and thus the one surface of the zipper 10 is completely in close contact with the outer circumference of the second roller 150.

As the first roller 130 and the second roller 150 are simultaneously rotated, the zipper which is inserted and pressed between the rollers can be transported. At this time, the adhesives can be spread on the other surface of the zipper that is in contact with the outer circumference of the first roller 130.

The second roller 150 and the third roller 160 serves to make the zipper 10 and the waterproof film 20 adhere to each other. That is, the third roller 160 is installed on the upper portion of the second roller 150 so that the outer circumference thereof is in close contact with the outer circumference of the second roller 150, and when the second roller 150 is rotated, its driving force is transferred to the third roller 160 to rotate the third roller 160 in the opposite direction. When the zipper 10 is drawn between the second roller 150 and the third roller 160, the waterproof film 20 that is wound on the film roll 170 is also drawn, and thus the zipper 10 and the waterproof roller 160 adhere to each other.

On the other hand, the film roll 170 is provided on the upper portion of the third roller 160, and the waterproof film 20 is transferred in the lower direction to be drawn between the second roller 150 and the third roller 160. In this case, since the waterproof film 20 is wound on the film roll 170 in a state where its surface on which the print layer is formed is directed outward, the print layer of the waterproof film 20 is directed downward when the waterproof film 20 is drawn between the second roller 150 and the third roller 160. Further, since the other surface of the zipper 10, that is, the surface on which the adhesives are spread, becomes the upper surface when the zipper 10 is drawn between the second roller 150 and the third roller 160, the surface on which the print layer of the waterproof film 20 that is drawn simultaneously with the zipper adheres to the other surface of the zipper 10. For reference, a plurality of guide rollers 171 for guiding the waterproof film 20 may be separately provided between the film roll 170 and the third roller 160.

The air heater 180 serves to inject high-temperature air to the adhesives that are spread on the other surface of the zipper to prevent the adhesive from getting hard before the zipper 10 is drawn between the second roller 150 and the third roller 160. The air heater 180 is provided on one side of the outer circumference of the second roller 150 to inject the high-temperature air. Accordingly, the adhesive is prevented from getting hard to lower the adhesive force before the zipper 10 is drawn between the second roller 150 and the third roller 160.

The zipper (hereinafter referred to as the “waterproof zipper”) to which the waterproof film 20 is attached by the adhesive unit 100 is transported to the heating unit 200 to pass through the heating process. The heating unit 200 is provided on one side of the adhesive unit 100, and serves to maintain the adhesive force of the adhesives until the pressure process is performed by the pressure unit 300 through applying of heat to the waterproof zipper 30 that is transported from the adhesive unit 100. As illustrated in FIGS. 7A and 7B, the heating unit 200 includes a heating case 210 and a heating bar 220.

The heating case 210 is formed to the long length in the transport direction of the waterproof zipper 30, and both ends of the heating case are open so that the waterproof zipper 30 is transported in the length direction. Further, at least one heating bar 220 is mounted inside the heating case 210 in the length direction to heat the waterproof zipper 30 being transported. On the other hand, it is preferable that on the front surface of the heating case 210, a cover 212 is installed to be hinge-engaged with the heating case 210. Accordingly, the heating bar 210 can be easily installed and replaced, and initially, a worker can easily transport the waterproof zipper from one end of the heating case 210 to the other end thereof.

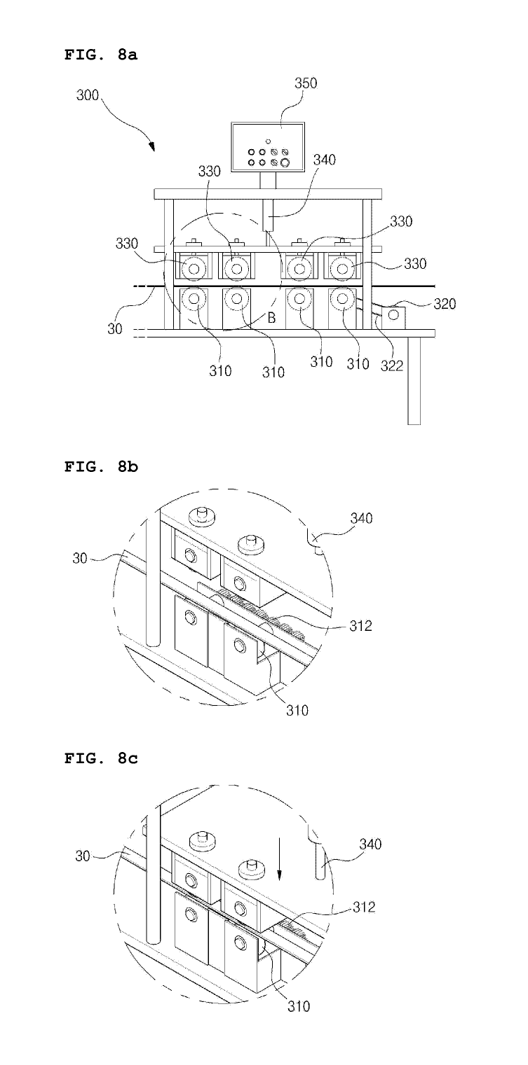

The pressure unit 300 is provided on one side of the heating unit 200, and serves to press the waterproof zipper that is heated by the heating unit 200 by pressing the waterproof zipper upward and downward through a plurality of pressure rollers. As illustrated in FIGS. 8A to 8C, the pressure unit 300 includes a plurality of lower rollers 310, a second drive motor 320, a plurality of upper roller 330, and a first cylinder 340.

The lower rollers 310 are arranged in the horizontal direction at predetermined intervals, and the waterproof zipper 30 that is transported form the heating unit 200 is placed on the lower rollers 310. In this case, on the outer circumference of the lower roller 310, a groove (not illustrated) that corresponds to the element 12 of the zipper may be formed, and this is to make the zipper 10 completely in close contact with the upper rollers 330. On the other hand, it is preferable that the lower rollers 310 are connected together with a plurality of gears 312 so that the lower rollers 310 can be simultaneously rotated.

The second drive motor 320 serves to provide a driving force to the lower rollers 310. The second drive motor 320 is connected to one lower roller 310 by a chain 322 in the same manner as the first drive motor 140 of the adhesive unit 100 provides a driving force to the first roller 130, and provides a driving force to rotate the lower rollers 310.

The upper rollers 330, the number of which corresponds to the number of the lower rollers 310, are installed on the upper portion of the lower rollers 310 to rise and fall. During falling, the outer circumference of the upper roller 330 is in close contact with the outer circumference of the lower roller 310, and when the lower roller 310 is rotated, the upper roller 330 is rotated in the opposite direction. IF the lower roller 310 and the upper roller 330 are simultaneously rotated, the waterproof zipper 30 that is transported between them receives a strong pressure, and thus the adhesive force between the waterproof film and the zipper is further strengthened. At this time, in order to strengthen the pressure that the upper roller 330 and the lower roller 310 apply to the waterproof zipper 30, the rising and falling of the upper roller 330 is controlled by the first cylinder 340, and the first cylinder 340 presses the upper roller 330 to the side of the lower roller 310.

The unexplained reference numeral 350 denotes a controller.

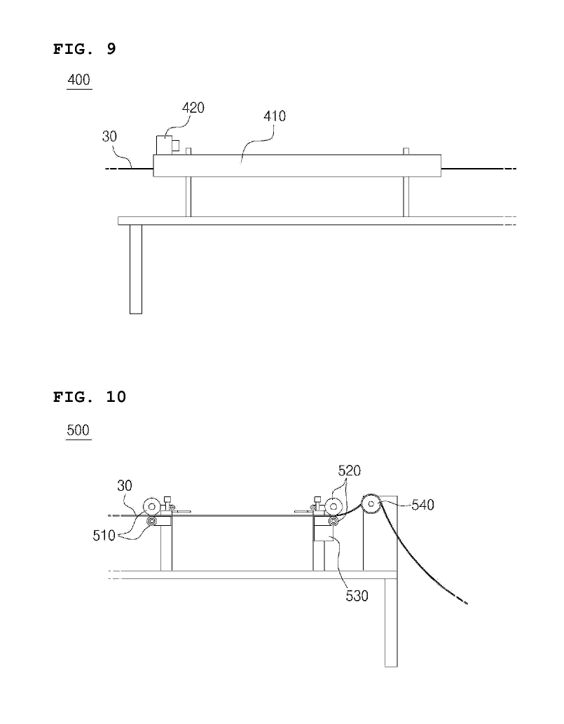

The cooling unit 400 is provided on one side of the pressure unit 300, and serves to cool the waterproof zipper of which the pressing is completed by the pressure unit 300. As illustrated in FIG. 9, the cooling unit 400 includes a cooling case 410 and a ventilator 420. The cooling case 410 is formed to the long length in the transport direction of the waterproof zipper 30, and both ends of the cooling case are open so that the waterproof zipper 30 can be transported in the length direction. Further, the ventilator 420 is mounted inside the cooling case 410 to supply low-temperature air to the inside of the cooling case 410. It is preferable that the cooling unit 400 is mounted on the side where the transported waterproof zipper 30 is drawn.

The drawing unit 500 is provided on one side of the cooling unit 400, and serves to draw and press the waterproof zipper that is transported after being cooled by the cooling unit with a pair of pressure rollers. As illustrated in FIG. 10, the drawing unit 500 includes a pair of first pressure rollers 510, a pair of second pressure rollers 520, a third drive motor 530, and a drawing guide roller 540.

The pairs of the first and second pressure rollers 510 and 520 are arranged at predetermined intervals in the transport direction of the waterproof zipper 30 that is transported from the cooling unit, and serves to transport and press the waterproof zipper 30. In this case, although not illustrated, the third drive motor 530 is connected to the pair of the second pressure rollers 520 to transfer the driving force, and by the rotation of the pair of the second pressure rollers 520, the waterproof zipper 30 is transported in the horizontal direction. Accordingly, a separate drive motor may not be connected to the pair of the first pressure rollers 510. Further, the drawing guide roller 540 is prepared at predetermined intervals from the pair of the second pressure rollers to guide the drawing of the waterproof zipper 30.

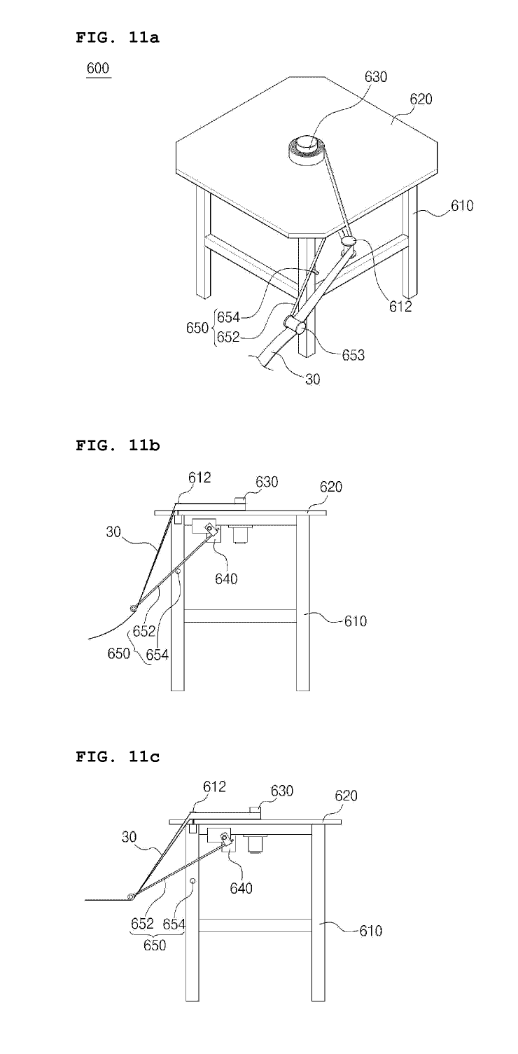

The winding unit 600 is prepared at predetermined intervals on one side of the drawing unit, and serves to make the drawn waterproof zipper automatically wound. As illustrated in FIGS. 11A to 11C, the winding unit 600 includes a main body 610, a plane plate 620, a winding roll 630, a fourth drive motor 640, and a limit switch 650.

The main body 610 is formed by coupling a plurality of vertical members and horizontal member to each other. The plane plate 620 is horizontally placed and coupled to the upper end of the main body 610, and the winding roll 630 is rotatably coupled to the center portion of the plane plate 620, so that the waterproof zipper 30 is wound on the winding roll 630 on the plane plate 620. The fourth drive motor 640 is mounted at the upper end of the main body 610, and is connected to the winding roll 630 to provide the driving force.

The limit switch 650 is mounted on the main body 610, and serves to control the driving of the fourth drive motor and the corresponding rotation of the winding roll 630. As illustrated in FIGS. 11B and 11C, it is preferable that the limit switch 650 includes a rotary member 652 and a stopper 654. It is preferable that one end of the rotary member 652 is mounted on one side of the upper end of the main body 610 to be rotatable at a predetermined angle, and a guide roller 653 for guiding the waterproof zipper 30 is formed at the other end of the rotary member 652. In addition, it is preferable that another guide roller 612 is mounted at the upper end of the main body 610. The stopper 654 is mounted for a predetermined distance from the upper end to the lower side of the main body 610 to stop the downward rotation of the rotary member 652.

Whether to drive the fourth drive motor 640 by the limit switch 650 is determined by whether the rotary member 652 is in contact with the stopper 654. That is, if the rotary member 652 is in contact with the stopper 654, the fourth motor 640 is stopped, and the rotary member 652 is rotated in an upward direction. If the rotary member 652 is rotated to be separate from the stopper 654, the fourth drive motor 640 is driven. That is, as illustrated in FIG. 11B, the fourth drive motor 640 is stopped in a state where the rotary member 652 is in contact with the stopper 654, and if the rotary member 652 is separated from the stopper 654 as illustrated in FIG. 11C, the fourth drive motor 640 is driven to rotate the winding roll 630. On the other hand, as illustrated in FIG. 11B, if the winding roll 630 is rotated, the waterproof zipper 30 is maintained in a tightly pulled state in the case where the winding process of the waterproof zipper 30 is performed, and thus the rotary member 652 continuously maintains the state where the rotary member 652 is separated from the stopper 654 to make the waterproof zipper 30 automatically wound on the winding roll 630.

After the winding process is completed, a process of hardening the waterproof zipper 30 is performed at a temperature of about 20° C., on 60% humidity condition, and for 48 hours, in a state where the waterproof zipper 30 is wound on the winding roll 630. After the hardening process is completed, the waterproof zipper 30 is unwound from the winding roll 630, and a process of cutting the center portion of the waterproof film 20 along the length direction is performed to complete the manufacturing of the waterproof zipper according to the present invention.

On the other hand, before the adhesive process is performed after completion of the water repellent process of the zipper 10, an ironing process may be additionally performed by an ironing unit 800. As illustrated in FIG. 6, the ironing unit 800 is prepared to be spaced apart for a predetermined distance from the adhesive unit 100, and serves to iron the zipper 10 to unfold wrinkles of the zipper 10 before the zipper is supplied to the adhesive unit 100. The reason why the zipper 10 is supplied to the adhesive unit 100 after the zipper 10 is ironed by the ironing unit 800 is to prevent the lowering of the adhesive force between the zipper and the waterproof film due to the wrinkles of the zipper.

For reference, according to the apparatus for manufacturing the waterproof zipper according to an embodiment of the present invention, since the driving force for transporting the zipper or waterproof zipper is provided by the first drive motor 140 of the adhesive unit 100, the second drive motor 320 of the pressure unit 300, the third drive motor of the drawing unit 500, and the fourth drive motor 640 of the winding unit 600, the worker's manual work is required only once in ironing, adhering, heating, pressing, cooling, drawing, and winding processes, and thereafter, the whole processes are automatically performed by the above-described driving means. On the other hand, the adhesive unit 100, the pressure unit 300, the cooling unit 400, and the drawing unit 500 can be all installed on a table (of which the drawing reference numeral is not indicated) having a predetermined height.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A waterproof zipper comprising:
a zipper having one surface to which a plurality of elements are attached so that the elements are engaged with each other in a length direction of the zipper; and
a waterproof film made of a transparent polyurethane material and having one surface on which a print layer is formed and which is attached to the other surface of the zipper.

2. The waterproof zipper according to claim 1, wherein the print layer of the waterproof film is an opaque layer on which opaque ink is coated, and a color of the other surface of the zipper is exposed through a transparent portion on which the print layer is not formed.

3. The waterproof zipper according to claim 1 or 2, wherein a water repellent material is spread on the one surface of the zipper.

4. A method of manufacturing a waterproof zipper, which attaches a waterproof film on which a print layer is formed to the other surface of a zipper having one surface to which a plurality of elements are attached so that the elements are engaged with each other in a length direction of the zipper, the method comprising:
a water repellent processing step of spreading a water repellent material on the one surface of the zipper;
an adhesion step of making the surface of the waterproof film adhere to the other surface of the zipper by spreading adhesives on the other surface of the zipper and making the zipper and the waterproof film simultaneously pass through a pressure roller;
a heating step of heating the waterproof zipper, in which the zipper and the waterproof film adhere to each other, while transporting the waterproof zipper;
a pressure step of transporting the heated waterproof zipper to a plurality of pressure rollers and pressing the heated waterproof zipper;
a cooling step of cooling the pressed waterproof zipper while transporting the pressed waterproof zipper;
a drawing step of drawing the cooled waterproof zipper;
a winding step of making the drawn waterproof zipper automatically wound on a winding roll;
a step of hardening the waterproof zipper wound on the winding roll; and
a cutting step of cutting a center portion of the waterproof film along the length direction while unwinding the waterproof zipper from the winding roll after the hardening is completed.

5. An apparatus for manufacturing a waterproof zipper, which attaches a waterproof film on which a print layer is formed to the other surface of a zipper having one surface to which a plurality of elements are attached so that the elements are engaged with each other in a length direction of the zipper, the apparatus comprising:
a water repellent processing unit spreading a water repellent material on the one surface of the zipper;
an adhesive unit making the surface of the waterproof film adhere to the other surface of the zipper by spreading adhesives on the other surface of the zipper and making the zipper and the waterproof film simultaneously pass through a pressure roller;
a heating unit provided on one side of the adhesive unit to heat the waterproof zipper while the waterproof zipper to which the waterproof film adheres through the adhesive unit is transported;
a pressure unit provided on one side of the heating unit to transport the waterproof zipper that is heated by the heating unit to a plurality of pressure rollers and to press the heated waterproof zipper;
a cooling unit provided on one side of the pressure unit to cool the waterproof zipper while the waterproof zipper that is pressed by the pressure unit is transported;
a drawing unit provided on one side of the cooling unit to draw the waterproof zipper that is cooled by the cooling unit to a pair of pressure rollers and to press the cooled waterproof zipper; and
a winding unit provided to be spaced apart for a predetermined distance from one side of the drawing unit to make the drawn waterproof zipper automatically wound.

6. The apparatus for manufacturing a waterproof zipper according to claim 5, wherein the water repellent processing unit comprises:
a housing having a hexahedron shape of which the front surface is open to form an inner space portion and having an inlet port and an outlet port through which the zipper passes;
a cover rotatably coupled to the housing to open or close the open portion of the housing;
a cylindrical main guide mounted in a position that is higher than the inlet port and the outlet port of the housing to project from a center portion of an inner surface of the housing in a horizontal direction;
first and second sub-guides mounted on both sides of a lower portion of the main guide on the inner surface of the housing; and
an injector mounted to be adjacent to an upper end corner of the inner surface of the housing to inject the water repellent material;
wherein in a process where the zipper having passed through the inlet port of the housing is guided to the outlet port of the housing by the first sub-guide, the main guide, and the second sub-guide, the water repellent material that is injected from the injector positioned on an upper side is spread on the one surface of the zipper.
